(19) United States
(12) Patent Application Publication
(10) Pub. No.: US 2025/0088895 A1
(43) Pub. Date: Mar. 13, 2025

(54) MANAGING DELAY STATUS REPORTING BASED ON WIRELESS COMMUNICATIONS SYSTEM CONGESTION

(71) Applicant: Lenovo (Singapore) Pte. Limited, Singapore (SG)

(72) Inventors: Joachim Löhr, Wiesbaden (DE); Prateek Basu Mallick, Dreieich (DE); Shwetha Sreejith, Steinbach (DE)

(73) Assignee: Lenovo (Singapore) Pte. Limited, Singapore (SG)

(21) Appl. No.: 18/829,934

(22) Filed: Sep. 10, 2024

Related U.S. Application Data
(60) Provisional application No. 63/538,213, filed on Sep. 13, 2023.

(51) Int. Cl. H04W 28/02; H04W 24/10; H04W 76/38

(52) U.S. Cl. CPC H04W 28/0236; H04W 24/10; H04W 76/38

(57) ABSTRACT

Various aspects of the present disclosure relate to managing delay status reporting (DSR) by a user equipment (UE) based on wireless communications system congestion. The techniques discussed herein provide multiple solutions that avoid unnecessary DSR reporting including cases where importance level based discarding is applied due to congestion in the wireless communications system. Conditions for DSR reporting, e.g., threshold based DSR reporting, are described for situations where importance level based discarding is enabled. In one solution threshold based DSR reporting is only allowed for certain PDU sets associated with a high importance level. For example, in one or more implementations the UE does not perform threshold based DSR reporting during time periods where importance level based discarding is enabled.

### RELATED APPLICATION

This application claims priority to U.S. Patent Application Ser. No. 63/538,213 filed Sep. 13, 2023 entitled “MANAGING DELAY STATUS REPORTING BASED ON WIRELESS COMMUNICATIONS SYSTEM CONGESTION,” the disclosure of which is incorporated by reference herein in its entirety.

### TECHNICAL FIELD

The present disclosure relates to wireless communications, and more specifically to managing delay status reporting based on wireless communications system congestion.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Various different data can be communicated between the network communication devices and the UEs having tight latency requirements, such as extended reality (XR) data. XR refers to real-and-virtual combined environments and human-machine interactions generated by computer technology and wearables. Examples of XR include virtual reality (VR), augmented reality (AR), and mixed reality (MR). Exceeding latency requirements within the wireless communications system for such data can make the data stale and unusable.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE receives, from a network equipment (NE), a first signaling indicating whether congestion is present in a wireless communications system; transmits, to the NE based at least in part on the first signaling indicating congestion is not present in the wireless communications system and on delay status reporting (DSR) being enabled, a second signaling indicating a DSR report for the UE; and suspends transmission, to the NE based at least in part on the first signaling indicating congestion is present in the wireless communications system, of a third signaling indicating the DSR report for the UE.

In some implementations of the method and apparatuses described herein, the UE receives, from the NE, a fourth signaling indicating whether DSR is enabled or disabled. Additionally or alternatively, the first signaling and the fourth signaling are both received from the NE in one message. Additionally or alternatively, the UE enables, in response to the first signaling, importance level based discarding of data at the UE. Additionally or alternatively, the UE receives, from the NE, a fourth signaling indicating that DSR is enabled; and transmits, to the NE, the second signaling based on the importance level based discarding of data being enabled and in response to the fourth signaling indicating that DSR is enabled. Additionally or alternatively, the UE receives, from the NE, a fourth signaling indicating a lack of congestion in the wireless communications system; and resumes transmission, to the NE based at least in part on the fourth signaling indicating the lack of congestion in the wireless communications system and on the DSR being enabled, a fifth signaling indicating a DSR report for the UE. Additionally or alternatively, a first packet data unit (PDU) set is associated with a first importance level and a second PDU set is associated with a second importance level that is of higher importance than the first importance level, and the UE: suspends transmission, to the NE based at least in part on the first signaling indicating congestion is present in the wireless communications system and on the DSR being enabled, of the third signaling indicating the DSR report for the UE, wherein the DSR report corresponds to the first PDU set; and transmits, to the NE based at least in part on the first signaling indicating congestion is present in the wireless communications system and on the DSR being enabled, of fourth signaling indicating an additional DSR report for the UE, wherein the additional DSR report corresponds to the second PDU set. Additionally or alternatively, the first importance level indicates low priority and the second importance level indicates high priority. Additionally or alternatively, the first importance level and the second importance level are each one of three or more importance levels, and the UE: transmits, to the NE, a fourth signaling indicating which of the three or more importance levels are deemed to be more important to the UE and which of the three or more importance levels are deemed to be less important to the UE. Additionally or alternatively the UE: receives, from the NE, a fourth signaling indicating a request for the DSR report for the UE; and transmits, to the NE, a fifth signaling indicating the DSR report for the UE. Additionally or alternatively, the fifth signaling also indicates a buffer status report (BSR) for the UE. Additionally or alternatively, the UEs transmits, to the NE based at least in part on the first signaling indicating congestion is present in the wireless communications system, a fourth signaling indicating a BSR for the UE. Additionally or alternatively, the DSR report indicates delay information for a first PDU set and delay information for a second PDU set that is inter-dependent on the first PDU set.

Some implementations of the method and apparatuses described herein may further include a UE for wireless communication. The UE receives a first signaling indicating whether congestion is present in a wireless communications system; receives a second signaling indicating a first discard timer configuration and a second discard timer configuration, wherein the second discard timer configuration is comprised of a shorter discard timer value than a discard timer value of the first discard timer configuration; and prohibits triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present.

In some implementations of the method and apparatuses described herein, the UE triggers transmission of the third signaling indicating the DSR report only for data for which the first discard timer configuration is applied in response to first signaling indicating congestion. Additionally or alternatively, the UE triggers the transmission of the third signaling indicating a DSR report in response to a remaining delay of data for which the first discard timer configuration is applied becoming less than a predefined threshold. Additionally or alternatively, the UE applies the second discard timer configuration for data that is associated with a low importance level in response to the first signaling indicating congestion is present in the wireless communications system. Additionally or alternatively, the UE applies the first discard timer configuration for data that is associated with a high importance level in response to the first signaling indicating congestion is present in the wireless communications system. Additionally or alternatively, the first signaling indicates that PDU set importance level (PSI) based discarding is enabled. Additionally or alternatively, the UE receives a fourth signaling indicating whether DSR is enabled or disabled. Additionally or alternatively, the UE receives a fourth signaling indicating a request for the DSR report for the UE; and transmits a fifth signaling indicating the DSR report for the UE. Additionally or alternatively, the fifth signaling also indicates a BSR for the UE. Additionally or alternatively, the DSR report indicates delay information for a first PDU set and delay information for a second PDU set that is inter-dependent on the first PDU set.

Some implementations of the method and apparatuses described herein may further include a processor for wireless communication. The processor receives, from a NE, a first signaling indicating whether congestion is present in a wireless communications system; transmits, to the NE based at least in part on the first signaling indicating congestion is not present in the wireless communications system and on DSR being enabled, a second signaling indicating a DSR report for a UE including the processor; and suspends transmission, to the NE based at least in part on the first signaling indicating congestion is present in the wireless communications system, of a third signaling indicating the DSR report for the UE.

In some implementations of the method and apparatuses described herein, the processor receives, from the NE, a fourth signaling indicating whether DSR is enabled or disabled. Additionally or alternatively, the first signaling and the fourth signaling are both received from the NE in one message. Additionally or alternatively, the processor enables, in response to the first signaling, importance level based discarding of data at the UE. Additionally or alternatively, the processor: receives, from the NE, a fourth signaling indicating that DSR is enabled; and transmits, to the NE, the second signaling based on the importance level based discarding of data being enabled and in response to the fourth signaling indicating that DSR is enabled. Additionally or alternatively, the processor: receives, from the NE, a fourth signaling indicating a lack of congestion in the wireless communications system; and resumes transmission, to the NE based at least in part on the fourth signaling indicating the lack of congestion in the wireless communications system and on the DSR being enabled, a fifth signaling indicating a DSR report for the UE. Additionally or alternatively, a first PDU set is associated with a first importance level and a second PDU set is associated with a second importance level that is of higher importance than the first importance level, and the processor: suspends transmission, to the NE based at least in part on the first signaling indicating congestion is present in the wireless communications system and on the DSR being enabled, of the third signaling indicating the DSR report for the UE, wherein the DSR report corresponds to the first PDU set; and transmits, to the NE based at least in part on the first signaling indicating congestion is present in the wireless communications system and on the DSR being enabled, of fourth signaling indicating an additional DSR report for the UE, wherein the additional DSR report corresponds to the second PDU set. Additionally or alternatively, the first importance level indicates low priority and the second importance level indicates high priority. Additionally or alternatively, the first importance level and the second importance level are each one of three or more importance levels, and the processor: transmits, to the NE, a fourth signaling indicating which of the three or more importance levels are deemed to be more important to the UE and which of the three or more importance levels are deemed to be less important to the UE. Additionally or alternatively, the processor: receives, from the NE, a fourth signaling indicating a request for the DSR report for the UE; and transmits, to the NE, a fifth signaling indicating the DSR report for the UE. Additionally or alternatively, the fifth signaling also indicates a BSR for the UE. Additionally or alternatively, the processor transmits, to the NE based at least in part on the first signaling indicating congestion is present in the wireless communications system, a fourth signaling indicating a BSR for the UE. Additionally or alternatively, the DSR report indicates delay information for a first PDU set and delay information for a second PDU set that is inter-dependent on the first PDU set.

Some implementations of the method and apparatuses described herein may further include a processor for wireless communication. The processor receives a first signaling indicating whether congestion is present in a wireless communications system; receives a second signaling indicating a first discard timer configuration and a second discard timer configuration, wherein the second discard timer configuration is comprised of a shorter discard timer value than a discard timer value of the first discard timer configuration; and prohibits triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present.

In some implementations of the method and apparatuses described herein, the processor triggers transmission of the third signaling indicating the DSR report only for data for which the first discard timer configuration is applied in response to first signaling indicating congestion. Additionally or alternatively, the processor triggers the transmission of the third signaling indicating a DSR report in response to a remaining delay of data for which the first discard timer configuration is applied becoming less than a predefined threshold. Additionally or alternatively, the processor applies the second discard timer configuration for data that is associated with a low importance level in response to the first signaling indicating congestion is present in the wireless communications system. Additionally or alternatively, the processor applies the first discard timer configuration for data that is associated with a high importance level in response to the first signaling indicating congestion is present in the wireless communications system. Additionally or alternatively, the first signaling indicates that PSI based discarding is enabled.

Some implementations of the method and apparatuses described herein may further include a base station for wireless communication. The base station transmits, to a UE, a first signaling indicating whether congestion is present in a wireless communications system; and receives, from the UE based at least in part on the first signaling indicating congestion is not present in the wireless communications system and on DSR being enabled, a second signaling indicating a DSR report for the UE.

In some implementations of the method and apparatuses described herein, the base station transmits, to the UE, a third signaling indicating whether DSR is enabled or disabled. Additionally or alternatively, the first signaling and the third signaling are both transmitted to the UE in one message. Additionally or alternatively, the base station: transmits, to the UE, a third signaling indicating that DSR is enabled; and receives, from the UE, the third signaling based on an importance level based discarding of data being enabled and in response to DSR being enabled. Additionally or alternatively, the base station: transmits, to the UE, a third signaling indicating a lack of congestion in the wireless communications system; and receives, from the UE based at least in part on the third signaling indicating the lack of congestion in the wireless communications system and on the DSR being enabled, a fourth signaling indicating a DSR report for the UE. Additionally or alternatively, a first PDU set is associated with a first importance level and a second PDU set is associated with a second importance level that is of higher importance than the first importance level, and the base station: receives, from the UE based at least in part on the first signaling indicating congestion is present in the wireless communications system and on the DSR being enabled, third signaling indicating an additional DSR report for the UE, wherein the additional DSR report corresponds to the second PDU set. Additionally or alternatively, the first importance level indicates low priority and the second importance level indicates high priority. Additionally or alternatively, the first importance level and the second importance level are each one of three or more importance levels, and the base station: receives, from the UE, a fourth signaling indicating which of the three or more importance levels are deemed to be more important to the UE and which of the three or more importance levels are deemed to be less important to the UE. Additionally or alternatively, the base station: transmits, to the UE, a third signaling indicating a request for the DSR report for the UE; and receives, from the UE, a fourth signaling indicating the DSR report for the UE. Additionally or alternatively, the fourth signaling also indicates a BSR for the UE. Additionally or alternatively, the base station receives, from the UE based at least in part on the first signaling indicating congestion is present in the wireless communications system, a fourth signaling indicating a BSR for the UE. Additionally or alternatively, the DSR report indicates delay information for a first PDU set and delay information for a second PDU set that is inter-dependent on the first PDU set.

Some implementations of the method and apparatuses described herein may further include a base station for wireless communication. The base station transmits a first signaling indicating whether congestion is present in a wireless communications system; transmits a second signaling indicating a first discard timer configuration and a second discard timer configuration, wherein the second discard timer configuration is comprised of a shorter discard timer value than a discard timer value of the first discard timer configuration; and receives a third signaling indicating a DSR report only for data for which the first discard timer configuration is applied in response to the first signaling indicating congestion is present.

In some implementations of the method and apparatuses described herein, the first signaling indicates that PSI based discarding is enabled.

Some implementations of the method and apparatuses described herein may further include a method performed by a UE, the method comprising: receiving, from a NE, a first signaling indicating whether congestion is present in a wireless communications system; transmitting, to the NE based at least in part on the first signaling indicating congestion is not present in the wireless communications system and on DSR being enabled, a second signaling indicating a DSR report for the UE; and suspending transmission, to the NE based at least in part on the first signaling indicating congestion is present in the wireless communications system, of a third signaling indicating the DSR report for the UE.

In some implementations of the method and apparatuses described herein, the method further comprises receiving, from the NE, a fourth signaling indicating whether DSR is enabled or disabled. Additionally or alternatively, the first signaling and the fourth signaling are both received from the NE in one message. Additionally or alternatively, the method further comprises enabling, in response to the first signaling, importance level based discarding of data at the UE. Additionally or alternatively, the method further comprises: receiving, from the NE, a fourth signaling indicating that DSR is enabled; and transmitting, to the NE, the second signaling based on the importance level based discarding of data being enabled and in response to the fourth signaling indicating that DSR is enabled. Additionally or alternatively, the method further comprises receiving, from the NE, a fourth signaling indicating a lack of congestion in the wireless communications system; and resuming transmission, to the NE based at least in part on the fourth signaling indicating the lack of congestion in the wireless communications system and on the DSR being enabled, a fifth signaling indicating a DSR report for the UE. Additionally or alternatively, a first PDU set is associated with a first importance level and a second PDU set is associated with a second importance level that is of higher importance than the first importance level, and the method further comprises: suspending transmission, to the NE based at least in part on the first signaling indicating congestion is present in the wireless communications system and on the DSR being enabled, of the third signaling indicating the DSR report for the UE, wherein the DSR report corresponds to the first PDU set; and transmitting, to the NE based at least in part on the first signaling indicating congestion is present in the wireless communications system and on the DSR being enabled, of fourth signaling indicating an additional DSR report for the UE, wherein the additional DSR report corresponds to the second PDU set. Additionally or alternatively, the first importance level indicates low priority and the second importance level indicates high priority. Additionally or alternatively, the first importance level and the second importance level are each one of three or more importance levels, and the method further comprises: transmitting, to the NE, a fourth signaling indicating which of the three or more importance levels are deemed to be more important to the UE and which of the three or more importance levels are deemed to be less important to the UE. Additionally or alternatively, the method further comprises: receiving, from the NE, a fourth signaling indicating a request for the DSR report for the UE; and transmitting, to the NE, a fifth signaling indicating the DSR report for the UE. Additionally or alternatively, the fifth signaling also indicates a BSR for the UE. Additionally or alternatively, the method further comprises transmitting, to the NE based at least in part on the first signaling indicating congestion is present in the wireless communications system, a fourth signaling indicating a BSR for the UE. Additionally or alternatively, the DSR report indicates delay information for a first PDU set and delay information for a second PDU set that is inter-dependent on the first PDU set.

Some implementations of the method and apparatuses described herein may further include a method performed by a UE, the method comprising: receiving a first signaling indicating whether congestion is present in a wireless communications system; receiving a second signaling indicating a first discard timer configuration and a second discard timer configuration, wherein the second discard timer configuration is comprised of a shorter discard timer value than a discard timer value of the first discard timer configuration; and prohibiting triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present.

In some implementations of the method and apparatuses described herein, the method further comprises triggering transmission of the third signaling indicating the DSR report only for data for which the first discard timer configuration is applied in response to first signaling indicating congestion.

Some implementations of the method and apparatuses described herein may further include a method performed by a base station, the method comprising: transmitting, to a UE, a first signaling indicating whether congestion is present in a wireless communications system; and receiving, from the UE based at least in part on the first signaling indicating congestion is not present in the wireless communications system and on DSR being enabled, a second signaling indicating a DSR report for the UE.

In some implementations of the method and apparatuses described herein, the method further comprises transmitting, to the UE, a third signaling indicating whether DSR is enabled or disabled. Additionally or alternatively, the first signaling and the third signaling are both transmitted to the UE in one message. Additionally or alternatively, the method further comprises: transmitting, to the UE, a third signaling indicating that DSR is enabled; and receiving, from the UE, the third signaling based on an importance level based discarding of data being enabled and in response to DSR being enabled. Additionally or alternatively, the method further comprises: transmitting, to the UE, a third signaling indicating a lack of congestion in the wireless communications system; and receiving, from the UE based at least in part on the third signaling indicating the lack of congestion in the wireless communications system and on the DSR being enabled, a fourth signaling indicating a DSR report for the UE. Additionally or alternatively, a first PDU set is associated with a first importance level and a second PDU set is associated with a second importance level that is of higher importance than the first importance level, and the method further comprises: receiving, from the UE based at least in part on the first signaling indicating congestion is present in the wireless communications system and on the DSR being enabled, third signaling indicating an additional DSR report for the UE, wherein the additional DSR report corresponds to the second PDU set. Additionally or alternatively, the first importance level indicates low priority and the second importance level indicates high priority. Additionally or alternatively, the first importance level and the second importance level are each one of three or more importance levels, and the method further comprises: receiving, from the UE, a fourth signaling indicating which of the three or more importance levels are deemed to be more important to the UE and which of the three or more importance levels are deemed to be less important to the UE. Additionally or alternatively, the method further comprises: transmitting, to the UE, a third signaling indicating a request for the DSR report for the UE; and receiving, from the UE, a fourth signaling indicating the DSR report for the UE. Additionally or alternatively, the fourth signaling also indicates a BSR for the UE. Additionally or alternatively, the method comprises receiving, from the UE based at least in part on the first signaling indicating congestion is present in the wireless communications system, a fourth signaling indicating a BSR for the UE. Additionally or alternatively, the DSR report indicates delay information for a first PDU set and delay information for a second PDU set that is inter-dependent on the first PDU set.

### BRIEF DESCRIPTION OF THE DRAWINGS

FIG. 1 illustrates an example of a wireless communications system in accordance with aspects of the present disclosure.

FIG. 2 illustrates an example of mapping PDU sets in accordance with aspects of the present disclosure.

FIG. 3 illustrates an example of lower layer mapping/handling in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a NE in accordance with aspects of the present disclosure.

FIGS. 7 and 8 illustrate flowcharts of methods performed by a UE in accordance with aspects of the present disclosure.

FIGS. 9 and 10 illustrate flowcharts of methods performed by a NE in accordance with aspects of the present disclosure.

### DETAILED DESCRIPTION

Transmitting data with tight latency requirements, such as data for XR, results in certain data (e.g., packet data unit (PDU)) sets not being usable at the receiving side if it is received beyond its delay budget. Accordingly, the NE takes into account the remaining delay budget for PDU sets when scheduling uplink (UL) resources. For uplink traffic the NE does not know exactly when a data packet arrives in the UE's buffer, so information regarding the remaining delay budget of the data pending in its buffer (e.g., the delay status reporting (DSR) report or information) is transmitted by the UE to the NE to provide some assistance information to the NE on the remaining delay budget for a certain PDU set. The NE can transmit an indication (e.g., a control signaling) to the UE indicating when the UE is to transmit the DSR to the NE.

A PDU set importance level (PSI) may also be associated with the data (e.g., a PSI for each PDU set). The PSI may also be referred to as simply an importance level. Various different rules can be applied to determine the importance level of a PDU set, but typically those PDU sets that are required for processing/decoding of other PDU sets (e.g., if there are some interdependencies of the PDU sets) have a high importance level.

Situations can arise where there is congestion on the UL from the UE to the NE, which can result in data being stuck at the UE and there are not sufficient resources to get all of the data through the UL channel to the NE. In such situations, the UE can apply PSI-based discarding where the UE discards less important packets in order to prioritize more important packets. E.g., there may be some unimportant packets in the UE buffer and higher importance data that arrives at the UE buffer later can be transmitted on the UL rather than lower importance data pending in the UE buffer. Accordingly, some lower importance data may be discarded rather than transmitted to the NE, which is also referred to PSI-based discarding. In one or more implementations, the NE transmits an indication (e.g., a control signaling) when to enable or activate PSI-based discarding and when to disable or deactivate PSI-based discarding.

One technique for implementing PSI-based discarding is a timer-based technique that uses packet data convergence protocol (PDCP) discard timer values (also referred to as congestion timer values). The NE configures different PDCP discard timer values for different PSI levels and the UE applies those values or configurations if congestion has been indicated to the UE. For example, for low importance PSI levels the discard timer value will be set to a short value, which means the UE will try a small number of times (e.g., once) to transmit data having the low importance PSI level and if not successful will discard the packet right away. For data having a higher high importance PSI level the UE will try additional times before discarding the packet. If the discard timer value for data expires (e.g., reaches 0), the UE discards or deletes the data.

Using the timer-based technique, the UE may trigger frequent DSR reports for low importance PDUs or PDU sets due to the discard timer value for low importance PDUs or PDU sets being a lower value. If certain (lower) PSI levels have a new discard timer value (higher than 0 but shorter than the normal timer value for a higher importance data) packets or PDU sets associated with those lower PSI levels would likely be reported as more urgent data since they have less time left until the discarding point. For example, if the discard timer value is usually set to 30 milliseconds and a DSR reporting threshold is set to 10 milliseconds, then after 20 milliseconds the discard timer drops to 10 milliseconds so the UE reports the DSR to the NE in order to inform the NE that there are only 10 milliseconds left for this data to be transmitted to the NE. If the PDCP discard time value is now set to a shorter value for the case of congestion, e.g. set to 15 ms, this can result in the UE triggering DSR reporting for the low importance PDU sets earlier and more often due to the shorter discard timer values, e.g., remaining delay drops below the configured threshold. Since the NE will not be able to know the PSI level of data in the UE buffer, this low importance data may be interpreted by the NE as high importance data that is close to the deadline and the NE may thus think the low importance data is to be treated urgently.

The techniques discussed herein provide multiple solutions that avoid unnecessary DSR reporting for the case where PSI-based discarding is applied due to congestion in the UL interface. New conditions for DSR reporting, e.g., threshold based DSR reporting, are discussed for the case that PSI-based discarding is enabled. In one solution threshold based DSR reporting is only allowed for certain PDU sets associated with a high importance (PSI) level. For example, in one or more implementations the UE does not perform threshold based DSR reporting during time periods where PSI-based discarding is enabled. The UE does not trigger a DSR report when the remaining delay budget is dropping below a configured threshold for cases that PSI-based discarding is enabled. However, the UE may still perform DSR reporting for other triggering events like periodic DSR reporting (if configured). By way of another example, DSR reporting is configured per PSI level. The NE can configure whether the UE should apply DSR reporting for PDU sets associated with the corresponding PSI level. E.g., DSR reporting per PSI level may only be applied during congestion when PSI-based discarding is applied.

Accordingly, the techniques discussed herein reduce or avoid unnecessary DSR reporting for the case where PSI-based discarding is applied due to congestion in the UL interface. For example, the discard timer values for lower importance PDU sets can be taken into account so that DSR reporting for lower importance PDU data sets is not triggered. Thus, scheduling of UL resources for lower importance PDU data sets during times of congestion in the wireless communications system can be reduced or eliminated.

Aspects of the present disclosure are described in the context of a wireless communications system.

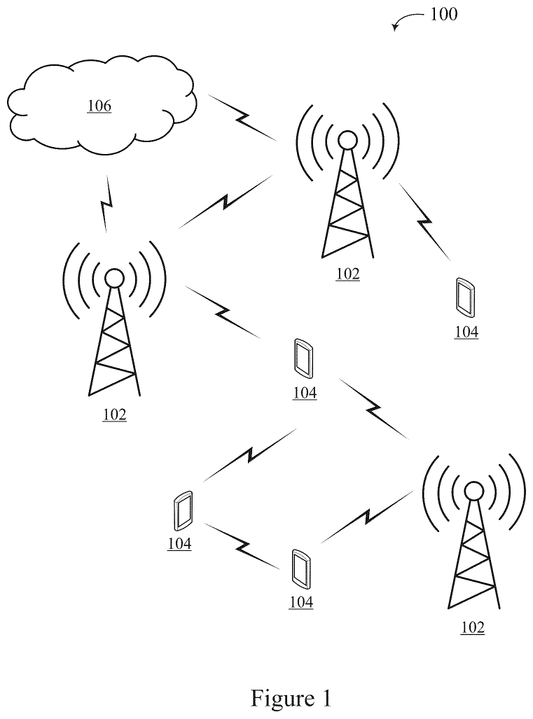

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The NE 102 transmits various control signalings to the UE 104, such as to indicate whether congestion is present in the wireless communications system 100 (e.g., on an UL channel between the UE 104 and the NE 102), whether DSR is enabled or disabled, and so forth. The UE 104 determines whether to transmit DSR reports based on various criteria, such as whether congestion is present in the wireless communications system 100, whether DSR is enabled or disabled, PSI levels of PDU sets in a buffer of the UE 104 waiting to be transmitted to the NE 102, discard timer values associated with the different PSI levels, and so forth.

One possible mapping option for XR-communication is that PDU sets of different importance level are mapped to the same QoS flow and radio bearer.

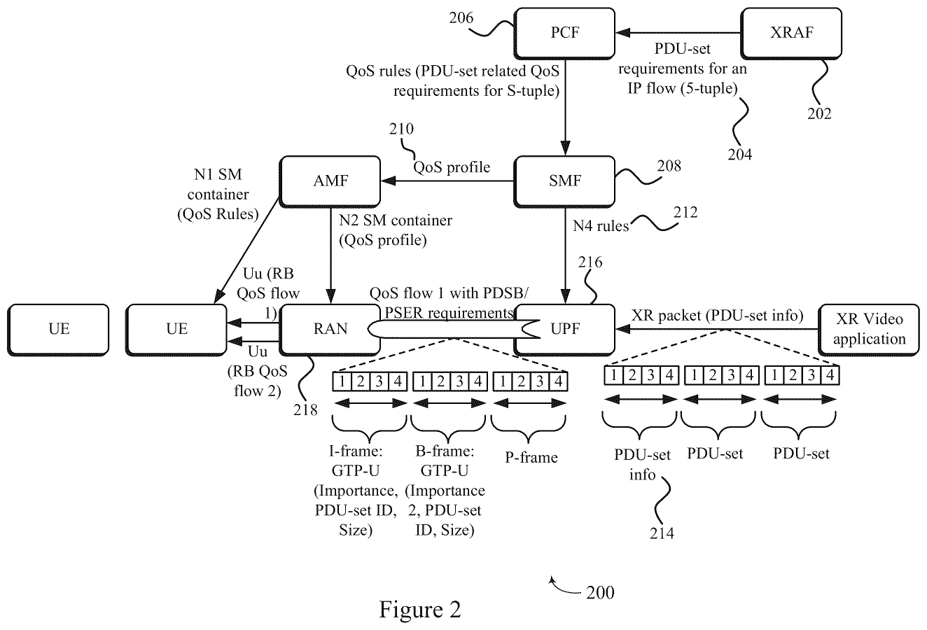

FIG. 2 illustrates an example 200 of mapping PDU sets in accordance with aspects of the present disclosure. The example 200 of mapping PDU sets of different importance level are mapped to the same QoS flow and radio bearer is, for example, that I-frame and P-frames of a video stream are carried by the same QoS flow/radio bearer.

In the example 200, PDU set integrated indication refers to whether all PDUs are needed for the usage of PDU set by application layer. PDU set importance is a parameter used to identify the importance of a PDU set within a QoS flow: RAN may use this parameter for PDU set level packet discarding, e.g. in presence of congestion.

At 202, the XR application function (XRAF) determines PDU-set requirements.

At 204, the PDU-set requirements include: PDU set QoS parameters (e.g., PDU set delay budget (PDSB or PSDB), PDU set error rate (PSER), PDU-set integrated indication (all PDUs of PDU-set are needed); burst periodicity (also includes frame rate values); description of service protocol (indicates real-time transport protocol (RTP)/real time streaming protocol (RTSP) header type to be used for PDU set identification at user plane function (UPF)).

At 206, the policy control function (PCF) determines QoS rules for the PDU-set.

At 208, at the session management function (SMF) the QoS profile of QoS flow includes the PDSB and PSER information.

At 210, the SMF also includes to the RAN via next-generation application protocol (NGAP) message the following: periodicity of UL and downlink (DL) traffic of the QoS flow which can include frame rate values (e.g., 15, 20, 30, 45, 60, 72, 90, 120 fps); jitter range associated with each periodicity (user plane function (UPF) derives jitter based on implementation per periodicity); optional end of burst indication.

At 212, the N4 rules tells the UPF to enable PDU-set inspection and how to route PDU-set packets.

At 214, the RTP header extension includes PDU-set info (importance, size).

At 216, the UPF determines PDU set from XR packets (different options) and routes packets to a corresponding QoS flow according to N4 rules. UPF also identifies importance of PDU-set.

At 218, the RAN receives QoS flow identifiers (QFIs), QoS profile of QoS flow from SMF (via access and mobility management function (AMF)) during PDU session establishment or modification which includes PSDB and PSER. RAN inspects general packet radio service (GPRS) tunnelling protocol user plane (GTP-U) headers and ensures all packets of the same PDU set are handled according to the QoS profile. RAN may drop lower importance PDU-sets if they cannot be delivered to the UE in time. The RAN may mark start and end PDU of PDU set and ensures PDU-set is delivered to the UE taking into account jitter according to PDSB requirements (e.g., jitter may be an assumed value). When the RAN receives the last PDU of PDU-set then the RAN may deliver the PDU-set according to PDSB.

The PSDB defines an upper bound for the delay that a PDU set may experience for the transfer between the UE and the N6 termination point at UPF (e.g., the time between reception of the first PDU and the successful deliver of the last arrived PDU of a PDU set). PSDB applies to the DL PDU set received by the UPF over the N6 interface, and to the UL PDU set sent by the UE. For a certain 5G QoS identifier (5QI) the value of the PSDB is the same in UL and DL. In one or more implementations, to support PSDB, it is assumed that there is a maximum duration threshold for inter arrival time between PDUs and first arrived PDU within the PDU set as per service level agreement (SLA) or pre-configuration.

In one or more implementations, PSDB is an optional parameter. If the PCF has sufficient information to determine the PSDB, the PSDB is used to support the configuration of scheduling and link layer functions.

The PSER defines an upper bound for the rate of PDU sets that have been processed by the sender of a link layer protocol (e.g., RLC in RAN of a 3^{rd} generation partnership project (3GPP) access) but that are not successfully delivered by the corresponding receiver to the upper layer (e.g., PDCP in RAN of a 3GPP access). Thus, the PSER defines an upper bound for a rate of non-congestion related packet losses. The purpose of the PSER is to allow for appropriate link layer protocol configuration (e.g., RLC and hybrid automatic repeat request (HARQ) in RAN of a 3GPP access). For every 5QI the value of the PSER is the same in UL and DL. If any PDU within the PDU set is not successfully transmitted, the PDU set is treated as error. In one or more implementations, a PDU set is considered as successfully delivered when all PDUs of a PDU set are delivered successfully.

Table 1 includes an example of audio payload types that may be supported by RTP.

TABLE 1
audio payload types

| Payload Type | | | | | |
|---|---|---|---|---|---|
| Number | Audio Format | Sampling Rate | | Throughput | |
| 0 | PCM mu-law | 8 | kilohertz (KHz) | 64 | kilobits per second (Kbps) |
| 1 | 1016 | 8 | KHz | 4.8 | Kbps |
| 3 | GSM | 8 | KHz | 13 | Kbps |
| 7 | LPC | 8 | KHz | 2.4 | Kbps |
| 9 | G.722 | 8 | KHz | 48-64 | Kbps |
| 14 | MPEG Audio | 90 | KHz | — | |
| 15 | G.728 | 8 | KHz | 16 | Kbps |

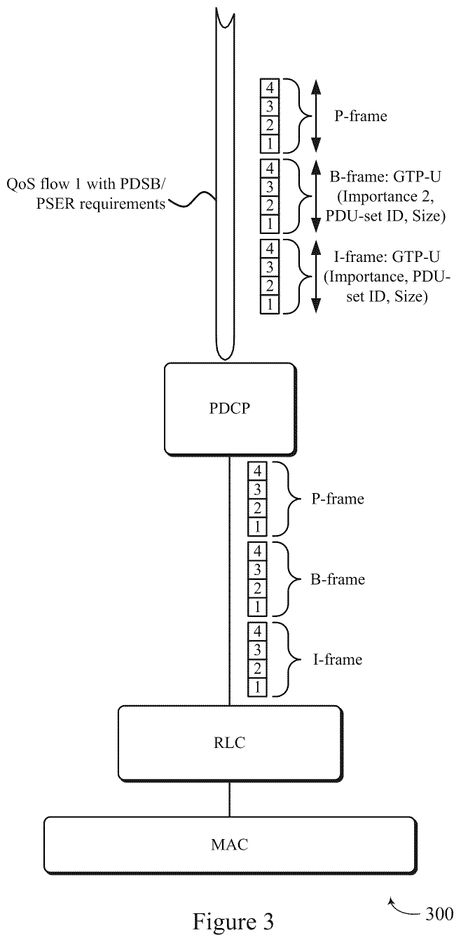

FIG. 3 illustrates an example 300 of lower layer mapping/handling in accordance with aspects of the present disclosure.

A QoS flow/radio bearer for XR traffic may carry PDU sets with a different importance level (PSI level), e.g., I-frames and P-frames of a video stream. According to the legacy QoS architecture all data packets of a radio bearer are experiencing the same QoS treatment. In order to allow for some distinguished handling of PDU sets associated with a high importance level in certain scenarios, e.g., prioritization of high importance data and discarding of low importance data in case of congestion, layer 2 procedures/mechanism are used.

With respect to DSR enhancements, the NE 102 can take knowledge of PDU set delay into account in scheduling transmissions, e.g., by giving priority to transmissions close to their delay budget limit, and by not scheduling (e.g., UL) transmissions exceeding a PDU set delay budget. The UE 104 can also take advantage of such knowledge to save UE's power by determining if an UL transmission (e.g., UL pose, or physical uplink shared channel (PUSCH)) corresponding to a transmission that exceeds its delay budget can be dropped. Additionally, the UE 104 does not need to wait for re-transmission of a physical downlink shared channel (PDSCH) that will never occur (e.g., discontinuous reception (DRX) retransmission timers can be stopped). For DL transmissions it is assumed that the NE 102 is aware of the remaining delay budget of the data pending for transmission, e.g., based on information provided by the session management function (SMF), and takes such knowledge into account in scheduling decisions.

For UL resource allocation, the UE 104 provides some assistance information regarding the remaining delay budget of the data pending in its buffer to the NE 102. The UE 104 provides information on the remaining delay budget of the data for which UL resources are requested. Such assistance information is referred to as DSR reporting. The PDU set delay budget (PSDB) information provided to the RAN is not sufficient. Since the NE 102 is not aware of the exact arrival time of UL data in the buffer and hence can also not be sure about the remaining (valid) time of data being pending in the buffer for transmission, the UE 104 provides this information, e.g., remaining delay information, within the DSR reporting. In one or more implementations a DSR medium access control (MAC) control element (CE) is introduced for XR-specific logical channel groups (LCGs) which includes the amount of data available for transmission and some remaining delay information associated with the data reported.

Furthermore, threshold based DSR reporting is supported, e.g., DSR reporting is triggered when remaining delay of a PDU or PDU set is below a NE 102 configured threshold. The threshold is configured per logical channel group (LCG). Configuring multiple thresholds for a LCG may also be supported.

With respect to PSI-based discarding, PSI can be considered for PDU set discarding in the presence of UL congestion. Therefore, in addition to the timer-based discard mechanism within a given PDCP entity, a PDCP discarding mechanism based on PDU set importance level (PSI) is introduced for XR communications.

The detailed discarding mechanism based on the importance level (PSI) of a PDU set in the case of congestion takes into account the discarding procedure. The NE 102 controls the PSI-based discarding at the UE 104 at the presence of congestion. To be more specific, the NE 102 explicitly orders the UE 104 to enable or disable PSI-based PDCP discarding, e.g., the NE 102 enables or disables PSI-based discarding based on a detected congestion. Essentially the NE 102 is responsible for the detection of congestion and the UE 104 just follows the NE 102 signaling. In one or more implementations, the NE 102 indicates to the UE 104 to apply a PSI-based XR discard mechanism via dedicated signaling.

Solutions for PSI-based discarding include a timer-based technique (Option A) or a threshold-based technique (Option B). When the NE 102 determines there is congestion and PSI-based discarding should be used it indicates to the UE 104 to apply PSI-based discarding via dedicated signaling. The two options will when activated behave differently. For Option A, the timer-based technique sets a new discard timer value, e.g., a congestion timer value. These congestion timer values can be configured with different values for different PSI levels. For Option B, the threshold-based technique drops directly PDU Sets which have PSI below the threshold (e.g., as soon as they enter the buffer or directly when the PSI-based discarding is activated in the UE 104).

The timer-based technique (Option A above), where different PDCP discard timer values (e.g., different timer values for different PSI levels) are configured or applied during congestion, may have some issues with the reporting of the remaining time in the DSR. This would essentially mean that if certain PSI levels got a new timer value (higher than 0 but shorter than the normal timer value) those packets would likely be reported as more urgent data since they have less time left until the discarding point. Essentially, the UE 104 triggers DSR reporting for the low importance PDUs or PDU sets earlier and more often due to the shorter PDCP discard timer values. Since the NE 102 will not be able to know what PSI level the data in the UE 104 buffer has, this data may be interpreted as high importance packets that is close to deadline and the NE 102 may thus think they need to be treated urgently.

The techniques discussed herein avoid unnecessary DSR reporting for the case where PSI-based discarding is applied due to congestion in the UL air interface.

XR (extended reality) is an umbrella term for different types of realities including VR, AR, and MR.

VR is a rendered version of a delivered visual and audio scene. The rendering is designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated in order to ensure that, from the user's perspective, items and sound sources remain consistent with the user's movements. Additional means to interact with the virtual reality simulation may be provided but are not strictly necessary.

AR is when a user is provided with additional information or artificially generated items or content overlaid upon their current environment. Such additional information or content will usually be visual and/or audible and their observation of their current environment may be direct, with no intermediate sensing, processing and rendering, or indirect, where their perception of their environment is relayed via sensors and may be enhanced or processed.

MR is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partial sensory inputs to fully immersive VR. A key aspect of XR is the extension of human experiences especially relating to the senses of existence (represented by VR) and the acquisition of cognition (represented by AR).

Many of the XR and configured grant (CG) use cases are characterized by quasi-periodic traffic (with possible jitter) with high data rate in DL (e.g., video steam) combined with the frequent UL (e.g., pose/control update) and/or UL video stream. Both DL and UL traffic are also characterized by relatively strict packet delay budget (PDB).

The set of anticipated XR and CG services has a certain variety and characteristics of the data streams (e.g., video) may change “on-the-fly”, while the services are running over NR. Therefore, additional information on the running services from higher layers, e.g., the QoS flow association, frame-level QoS, PDU set-based QoS, XR specific QoS etc., may be beneficial to facilitate informed choices of radio parameters. It is clear that XR application awareness by UE and gNB would improve the user experience, improve the NR system capacity in supporting XR services, and reduce the UE power consumption.

An Application Data Unit (ADU) or PDU set is the smallest unit of data that can be processed independently by an application (such as processing for handling out-of-order traffic data). A video frame can be an I-frame, P-frame, or can be composed of I-slices, and/or P-slices. I-frames/I-slices are more important and larger than P-frames/P-slices. A PDU set can be one or more I-slices, P-slices, I-frame, P-frame, or a combination of those. The definition of a PDU set in 3GPP is the following: one or more PDUs carrying the payload of one unit of information generated at the application level (e.g. frame(s) or video slice(s) etc. for XR Services), as defined in 3GPP technical specification (TS) 23.501.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

With respect to packet delay budget, the latency requirement of XR traffic in RAN side (e.g., air interface) is modelled as packet delay budget (PDB). The PDB is a limited time budget for a packet to be transmitted over the air from a NE 102 to a UE 104.

For a given packet, the delay of the packet incurred in air interface is measured from the time that the packet arrives at the NE 102 to the time that it is successfully transferred to the UE 104. If the delay is larger than a given PDB for the packet, then the packet is said to violate PDB, otherwise the packet is said to be successfully delivered.

The value of PDB may vary for different applications and traffic types, which can be 10-20 milliseconds (ms) depending on the application.

5G arrival time of data bursts on the downlink can be quasi periodic, e.g., periodic with jitter. Some of the factors leading to jitter in burst arrival include varying server render time, encoder time, RTP packetization time, link between server and 5G gateway etc. In one or more implementations, assumptions for XR evaluation model DL traffic arrival jitter using truncated Gaussian distribution with mean: 0 ms, std. dev: 2 ms, range: [−4 ms, 4 ms] (baseline), [−5 ms, 5 ms] is taken into account.

Applications can have a certain delay requirement on a PDU set, that may not be adequately translated into packet delay budget requirements. For example, if the PDU set delay budget (PSDB) is 10 ms, then PDB can be set to 10 ms only if all packets of the PDU set arrive at the 5G system at the same time. If the packets are spread out, then the PDU set delay budget is measured either in terms of the arrival of the first packet of the PDU set or the last packet of the PDU set. In either case, a given PSDB will result in different PDB requirements on different packets of the PDU set. It is observed that specifying the PSDB to the 5G system can be beneficial.

With respect to delay-aware communication, if one or both of the scheduler or the UE 104 is aware of delay budgets for a packet/ADU, the NE 102 can take this knowledge into account in scheduling transmissions, e.g., by giving priority to transmissions close to their delay budget limit, and by not scheduling (e.g., UL) transmissions; the UE 104 can also take advantage of such knowledge to determine 1) if an UL transmission (e.g., physical uplink control channel (PUCCH) in response to PDSCH, UL pose, or PUSCH) corresponding to a transmission that exceeds its delay budget can be dropped (additionally, no need to wait for re-transmission of a PDSCH and no need to keep the erroneously received PDSCH in buffer for soft combining with a re-transmission that never occurs) or 2) how much of its channel occupancy time in case of using unlicensed spectrum can be shared with the NE 102.

The remaining delay budget 1) for a DL transmission can be indicated to the UE 104 via various signalings such as in a downlink control information (DCI) (e.g., for a packet of a video frame/slice/ADU) or via a MAC-CE (e.g., for an ADU/video frame/slice) and 2) for an UL transmission can be indicated to the NE 102 via an UL transmission of various signalings such as uplink control information (UCI), PUSCH transmission, etc.

With respect to XR services, the support of XR services may require high data rate and low latency communications.

XR-Awareness relies on QoS flows, PDU Sets, Data Bursts and traffic assistance information. To enable PDU Set based QoS handling, PDU Set QoS Parameters may be provided by the SMF to the NE 102 as part of the QoS profile of the QoS flow (at least one of them shall be provided):
PDU Set Delay Budget (PSDB): the upper bound for the duration between the reception time of the first PDU (at the user plane function (UPF) for DL, at the UE for UL) and the time when all PDUs of a PDU set have been successfully received (at the UE in DL, at the UPF in UL). A QoS Flow is associated with only one PSDB, and when available, it applies to both DL and UL and supersedes the PDB of the QoS flow. The access network (AN) PSDB is derived by subtracting the core network (CN) PDB from the PSDB.
PDU Set Error Rate (PSER): the upper bound for a rate of non-congestion related PDU set losses between RAN and the UE. A QoS Flow is associated with one PSER, and when available, it applies to both DL and UL and supersedes the packet error rate (PER) of the QoS flow. A PDU set is considered as successfully delivered only when all PDUs of a PDU set are delivered successfully.
PDU Set Integrated Handling Information (PSIHI): indicates whether all PDUs of the PDU set are needed for the usage of the PDU set by the application layer. The PDU set QoS parameters are common for all PDU sets within a QoS flow.

In addition, the UPF can identify PDUs that belong to PDU sets, and may determine the following PDU Set Information which it sends to the NE 102 in the GTP-U header: PDU Set Sequence Number; indication of End PDU of the PDU Set; PDU Sequence Number within a PDU Set; PDU Set Size in bytes; PDU Set Importance (PSI), which identifies the relative importance of a PDU Set compared to other PDU Sets within the same QoS Flow.

Traffic assistance information may also be provided by 5GC to the NE 102: via time-sensitive communications (TSC) assistance information (TSCAI) (for both guaranteed flow bit rate (GBR) and non-GBR QoS flows)—UL and/or DL Periodicity, N6 Jitter Information (e.g., between UPF and Data Network) associated with the DL Periodicity; indication of End of Data Burst in the GTP-U header of the last PDU in downlink.

In the uplink, the UE 104 identifies PDU Sets and Data Bursts dynamically, including PSI.

With respect to jitter aspects of XR, the packet arrival rate is determined by the frame generation rate, e.g., 60 frames per second (fps). Accordingly, the average packet arrival periodicity is given by the inverse of the frame rate, e.g., 16.6667 ms=1/60 fps. The periodic arrival without jitter gives the arrival time at gNB for packet with index k (=1, 2, 3 . . . ) as

k/F*1000 [ms],

where F is the given frame generation rates (per second). Note that this periodic packet arrival implicitly assumes fixed delay contributed from network side including fixed video encoding time, fixed network transfer delay, etc.

However, the varying frame encoding delay and network transfer time introduces jitter in packet arrival time at the NE 102 which. The jitter can be modelled as a random variable added on top of periodic arrivals. The jitter follows truncated Gaussian distribution with following statistical parameters shown in Table 2.

TABLE 2
Statistical parameters for jitter

| | | Baseline value for | Optional value for |
|---|---|---|---|
| Parameter | unit | evaluation | evaluation |
| Mean | ms | 0 | |
| STD | ms | 2 | |
| Truncation range | ms | [−4, 4] | [−5, 5] |

Note that the given parameter values and considered frame generation rates (e.g., 60 or 120) ensure that packet arrivals are in order (e.g., arrival time of a next packet is always larger than that of the previous packet).

Thus, the periodic arrival with jitter gives the arrival time for packet with index k (=1, 2, 3 . . . ) as

$$offset + k / F * 1000 + J [ ms ] ,$$

where F is the given frame generation rates (per second) and J is a random variable capturing jitter. Note that actual traffic arrival timing of traffic for each UE could be shifted by the UE specific arbitrary offset.

In one or more implementations, the network configuring the UE whether to trigger delay status reporting is taken into consideration.

In one or more implementations, when the UE triggers reporting delay information for a LCG and UE also reports the buffer status associated with the remaining time is taken into consideration.

In one or more implementations, defining a single MAC CE for the DSR reporting (including the buffer status) is taken into consideration. Whether this extends buffer status report (BSR) MAC CE or is a new MAC CE is also taken into consideration.

In one or more implementations, single value per LCG being sufficient is taken into consideration. Additionally or alternatively, the scheduler using more information is taken into consideration.

In one or more implementations, a new separate MAC CE for DSR (remaining delay and associated data volume) reporting, e.g., DSR reporting is not coupled with BSR reporting, is taken into consideration.

In one or more implementations, support threshold based DSR reporting, e.g., DSR reporting is triggered when remaining delay of a PDU/PDU set is below a network (e.g., NE 102) configured threshold, is taken into consideration. The threshold is configured per LCG. Configuring multiple thresholds for a LCG is optionally supported.

In one or more implementations, the UE 104 does not perform delay status reporting for periods where the NE 102 indicates congestion. For example, the UE 104 suspends or disables delay status reporting for the time periods where the NE 102 indicates that congestion happens on the UL, e.g., Uu UL air interface, to the UE 104. In one example the UE 104 applies different PDCP discard timer values for PDU sets associated with a low importance level (e.g., PSI) in case of congestion. As mentioned above, when the NE 102 determines there is congestion it may indicate that PSI-based discarding should be used in the UE 104, e.g., discarding based on the importance level (PSI) of a PDU set, the NE 102 indicates to the UE 104 to apply PSI-based discarding via dedicated signaling. This PSI-based discarding can be implemented by applying a different PDCP discard timer configuration or value for different PSI levels when the NE 102 indicates that there is congestion, e.g., the UE 104 uses a shorter PDCP discard timer value for low importance PDU sets in case of congestion. According to one example, the UE 104 disables, deactivates, or suspends DSR reporting in response to receiving a notification, e.g., PDCP control PDU or MAC CE or any other signaling message, indicating that there is congestion, e.g. PSI-based discarding is enabled. Upon reception of a notification from the NE 102 that there is no congestion (anymore) on the air interface (UL), e.g., normal mode of operation, the UE 104 activates, enables, or resumes the DSR reporting.

According to one example, the UE 104 does not perform threshold based DSR reporting during time periods where PSI-based discarding is enabled. In one example the UE 104 does not trigger a DSR report when the remaining delay budget is dropping below a configured threshold for cases that PSI-based discarding is enabled. The UE 104 may still perform DSR reporting for other triggering events like periodic DSR reporting (if configured).

Suspending DSR reporting, e.g., threshold based DSR reporting, during time periods where PSI-based discarding is applied addresses the concerns with the reporting of remaining time in the DSR. As explained above if certain PSI levels got a new PDCP discard timer value (e.g., during congestion) (higher than 0 but shorter than the normal timer value) those packets would likely be reported as more urgent data, e.g., threshold-based DSR reports are more often triggered for those packets, since they have less time left until the discarding point. Since the NE 102 will not be able to know what PSI level the data in the UE 104 buffer has, this data may be interpreted as high importance packets that is close to deadline and the NE 102 may thus think they need to be treated urgently.

In one or more implementations, the NE 102 explicitly indicates whether DSR reporting, e.g. threshold based DSR reporting, is enabled or disabled during time periods where PSI-based discarding is applied. According to one example, the NE 102 signals within the signaling message indicating to apply PSI-based discarding, e.g., a new field within the signaling message, whether threshold based DSR reporting is enabled or disabled.

In another example, the NE 102 explicitly activates or deactivates DSR reporting. In one example the NE 102 enables or disables DSR reporting by means of new control signaling for cases when the UE 104 is configured for DSR reporting. For example when PSI-based discarding is activated by the NE 102, e.g., for the case of congestion, the NE 102 can disable DSR reporting. In one example the new control signaling enabling or disabling DSR reporting is conveyed in the control message activating the PSI-based discarding. In one example the enabling or disabling is signaled per LCG. In another variant the DSR reporting is enable or disabled per the UE 104 or per MAC entity.

In one or more implementations, DSR reporting is configured per PSI level. According to one example, the NE 102 configures whether the UE 104 should apply DSR reporting for PDUs or PDU sets associated with the corresponding PSI level. In one example of such configuration, e.g., DSR reporting per PSI level, is only applied during congestion when PSI-based discarding is applied. For cases of non-congestion, when no PSI-based discarding is applied, the per-PSI level DSR reporting configuration is not applicable. In one example threshold based DSR reporting is configured per PSI level, e.g., periodic DSR reporting (if configured) is transmitted regardless of the PSI level of a PDU set or PDU.

In one or more implementations, the NE 102 requests the transmission of a DSR report by the UE 104. According to one example, new control signaling sent from the NE 102, e.g., NE 102, orders the UE 104 to transmit a DSR report. In one example the new control signaling is a field in a DCI or physical downlink control channel (PDCCH). In one example the DCI is scheduling UL resources. According to one example the NE 102 requests the transmission of a BSR and a DSR report, e.g., transmission of BSR and DSR MAC CE. The BSR includes an indication of an amount of data in the buffer of the UE 104 waiting to be transmitted to the NE 102. According to one example, the UE 104 includes in the aperiodic NE 102 requested DSR report the remaining delay information and associated data volume for all logical channels (LCHs) or LCGs for which DSR reporting is configured. In one example the UE 104 includes remaining delay information of the most urgent data, e.g., lowest remaining delay budget, for each LCG or logical channel (LCH). In another example the UE 104 includes in the NE 102 requested DSR report remaining delay information and the associated data volume for multiple PDU sets, e.g., multiple DSR information per LCG. In one example the NE 102 requested DSR report is linked to a SR configuration, e.g., in case the UE 104 is requested to transmit a DSR MAC CE, but the UE 104 has no uplink shared channel (UL-SCH) resource available, the UE 104 triggers a scheduling request (SR) in order to request UL resources for the DSR MAC CE.

In one or more implementations, a PSI based threshold for DSR reporting is introduced. The UE 104 performs DSR reporting for PSI levels which are above a configured threshold for cases that PSI-based discarding is applied. According to one example, the UE 104 performs threshold based DSR reporting only for PDUs or PDU sets having a PSI level which is exceeding a preconfigured threshold for cases that PSI-based discarding is applied. For cases that PSI-based discarding is not applied, e.g., non congestion mode, the UE 104 performs threshold based DSR reporting for all PSI levels, e.g., DSR reporting is done regardless of the PSI level of a PDU or PDU set.

In one or more implementations the UE 104 applies DSR reporting for cases when PSI-based discarding is enabled, e.g., in the case of congestion, only for PDU sets or PSI levels for which the PDCP discard timer value was not set to a shorter value in response to enabling PSI-based discarding. According to one example, the UE 104 applies threshold based DSR reporting only for PDU sets for which the PDCP discard timer value was not changed or set to a short timer value in response to enabling PSI-based discarding.

In one or more implementations, the UE 104 reports buffer status only for PDU or PDU set having a remaining delay budget which is greater or equal to a preconfigured threshold. According to one example, the amount of data available for transmission in the PDCP layer includes only PDUs or PDU sets that are having a remaining delay budget that is greater than or equal to the threshold. In one example the BSR triggering is not impacted by the PSI level of a PDU or PDU set, e.g., BSR triggering is done based on priority and data availability.

According to another variant a BSR is triggered based on the PSI level of the PDU or PDU set, e.g., when data of a certain PSI level (e.g., PSI level exceeding a preconfigured threshold) becomes available for transmission (data arrives at the UE 104 buffer e.g., in PDCP), a BSR is triggered. According to one example the new definition of amount of data being available for transmission for the purpose of MAC buffer status reporting, e.g., considering only PDUs or PDU sets having a remaining delay budget which is greater or equal to a preconfigured threshold in the reported buffer status, is only applicable for cases when PSI-based discarding is applied, e.g., during congestion.

In one or more implementations, a BSR is triggered at the UE 104 or MAC when the UE 104 receives a notification from the NE 102 to enable PSI-based discarding. According to one example a new BSR trigger is introduced, e.g., based on the indication to enable PSI-based discarding. This can be only applicable to a XR BSR, e.g., BSR MAC CE with new BSR tables. In one example a DSR is triggered in response to the reception of the NE 102 indication to enable PSI-based discarding.

In one or more implementations, the UE 104 triggers a BSR report in case the amount of discarded PDUs or PDU sets exceeds a preconfigured threshold. In general NE 102 benefits from a notification by the UE 104 about UL data-which were reported in a BSR previously-which was discarded at the transmitter side before transmission, e.g., for which the delay budget is exceeded. NE 102 can take such knowledge into account for an efficient resource allocation, e.g., avoiding to issue further UL grants for data pending in UE's buffer which is of no use for the user. According to this implementation the UE 104 notifies the NE 102 with an updated BSR only for cases that the amount of discarded data was significant, e.g., amount of discarded data exceeding a predefined threshold. In one example the UE 104 triggers a DSR report for cases when the amount of discarded PDUs or PDU sets exceeds a preconfigured threshold. Similar to an update BSR report, NE 102 would also benefit by an updated DSR report for cases that the amount discarded data was significant.

In one or more implementations, the UE 104 reports the associated PSI level with the remaining delay information. According to one example, the UE 104 includes in a DSR report also the associated PSI level for the data for which the remaining delay information is signaled. In one example a DSR report includes the one or more of the following information: remaining delay information, amount of data associated with the remaining delay information, or PSI level of the data for which remaining delay information is reported.

According to one example, the UE 104 reports the range of PSI levels that the PDU sets of a LCH or LCG are associated with to the NE 102. In one example the UE 104 reports the supported or used PSI levels for a LCH or LCG to the NE 102 as part of the UE 104 assistance information. Based on the reported PSI range NE 102 can configure the PSI-based discarding, e.g., different discard timer values for different PSI levels or determining PSI threshold.

In one example some statistics like 10 percent PSI level X or 20 percent PSI level Y are reported to the NE 102.

In one or more implementations, the UE 104 provides information to the NE 102 about the PSI levels which are important and respectively information on which PSI levels are discardable.

In one example there are 16 PSI levels defined, e.g., those PSI levels are defined by SA4. The PSI selection may vary between codecs such H.264 or high efficiency video coding (HEVC), but a common rule is that the PSI value is based on if this PDU set is needed for the processing of other PDU Sets (e.g., inter-dependency)—this is especially crucial for XR services. Essentially in one example the PSI levels which are considered as important (and hence should not be discarded) are the PSI levels which are used for PDU sets which are necessary for the processing of any other PDU set. Unimportant PSI levels are associated with PDU sets that are not necessary for the processing of any other PDU set. Such PDU sets can be discarded, if needed, e.g., in the case of congestion.

In one or more implementations, it is a prerequisite that the RAN is aware of how PSIs are used by a UE 104 application. Without sufficient knowledge of PSI, the NE 102 is not able to properly set a sensible PSI threshold or define a sensible PDCP discard timer configuration that can strike a balance between alleviation of congestion and the resultant user experience. PSI selection can by influenced by many different things such as codec and inter-dependency, and different applications (e.g., video, audio, text/metadata, image) can have different ways of PDU Set marking. Therefore, according to one or more implementations the UE 104 provides some information to the NE 102, e.g., as part of the UE 104 assistance information, on the usage of the PSI levels for a certain application, data radio bearer (DRB), or LCH, e.g., information on the PSI level distribution. In one example the UE 104 provides the PSI levels to the NE 102 which are considered as unimportant and therefore can be in some situations discarded, e.g., the PDU sets which are not needed for the processing of other PDU sets. In one example the UE 104 provides the PSI level(s) to the NE 102 which are considered as important and therefore are not to be discarded due to their inter-dependency.

In one or more implementations, the NE 102 provides a PDCP discard timer configuration, e.g., discard timer value, for “important” and “unimportant PDU sets” which is to be applied by the UE 104 for cases when PSI-based discarding is enabled. According to one example, the NE 102 provides a configuration of congestion PDCP discard timer values to the UE 104, where the configuration includes a PDCP discard timer value for important PDU set(s)/PSI levels and one PDCP discard timer value for non-important PDU set(s)/PSI levels. The UE 104 applies those discard timer values when PSI-based discarding is enabled by the NE 102. The UE 104 knows based on the application layer (AL) information, e.g., inter-layer communication which is up to the UE 104 implementation, which PSI levels are important PSI levels and correspondingly which PSI levels are considered as non-important and applies the corresponding discard timer values. The advantage of this approach is that the NE 102 does not need to be aware of the PSI level distribution of a DRB, LCH, or service, but only configures two PDCP discard timer values, e.g., one for important “non discardable” PSI levels and one for non-important “discardable” PSI levels. The association of the PDCP discard timer values to the corresponding PSI levels is done at the UE 104 side. In one more implementations, the NE 102 provides only a PDCP discard timer configuration, e.g. discard timer value, for the lower importance data/PDU sets, which is to be used for the case when PSI based discarding is enabled. According to one example, the NE 102 provides a configuration of a congestion PDCP discard timer value to the UE 104, where the configuration includes a PDCP discard timer value for non-important PDU set(s)/PSI levels. The UE 104 applies this discard timer value when PSI-based discarding is enabled by the NE 102. The UE 104 knows based on the application layer (AL) information, e.g., inter-layer communication which is up to the UE 104 implementation, which PDU set(s)/PSI levels are un-important and applies the discard timer value for the corresponding PDU sets which are considered as un-important/of lower importance.

In one or more implementations, the data volume which is included in a DSR report only includes data which has not been delivered to lower layers for transmission. According to one example, the amount of data associated with the remaining delay information includes only PDCP PDUs or service data units (SDUs) which have not been delivered to lower layer for transmission. In one example for the purpose of DSR reporting in MAC, the transmitting PDCP entity considers the following as associated PDCP data volume: the PDCP SDUs of the PDU set for which no PDCP Data PDUs have been constructed; and the PDCP Data PDUs of the PDU set that have not been submitted to lower layers.

In one or more implementations, the UE 104 triggers only one DSR report per PDU set. For cases when PDUs of a PDU set arrive at different times in the UE 104 buffer, e.g., PDCP layer, the PDCP discard timer values of the PDUs belonging to one PDU set may have different values since the PDCP discard timers have been started at different points of time. According to one example, the UE 104 triggers only one DSR report, e.g., threshold based DSR trigger, for a PDU set even though multiple PDCP discard timers may drop below a preconfigured threshold. In one example the UE 104 cancels a DSR trigger for a PDU set once there is already one pending DSR trigger for that PDU set.

In one or more implementations, a DSR report includes the remaining delay information for a PDU set and delay information for an inter-dependent PDU set or LCH. Emerging use cases such as AR/VR and holographic communications encompass multiple simultaneous traffic flows where the arrival of packets are synchronized. Incorporating the five senses in the XR experience necessitates more stringent end-to-end latency, jitter, and synchronization. Such services have even more stringent requirements on the wireless network since holographic flows require very tight synchronization of the five senses. Therefore, when designing NR enhancements to support XR applications, multimodal interaction techniques are considered, which employ several human senses simultaneously. Multimodal interaction can transform how people communicate remotely, practice for tasks, entertain themselves, process information visualizations, and make decisions based on the provided information. For XR applications transmitted via a mobile communication system like NR the interactions between different input signals can be translated to some inter-dependencies between transmissions of different bearers, LCHs, or flows, e.g., PDU set level QoS requirement(s) for XR and the dependency of different QoS flows are used. In one example the NE 102 configures QoS related requirements for a set of LCH or bearers which are inter-related/dependent. In one example, a radio bearer, LCH, or RLC bearer is linked to a set of other radio bearer, LCH, or RLC bearer. Those bearers or LCHs may for example carry different types of streams, e.g., corresponding to different human senses, of a multi-modal services like tactile or haptic communications. The NE 102 may configure QoS parameter, like e.g., latency requirements respectively latency bounds, for the group of bearers or LCHs in order to enforce the relationship or inter-dependencies among those different bearers or LCH. In the legacy QoS requirements are configured per bearer or LCH, however this may not be sufficient for the new emerging XR applications. Therefore, according to one or more implementations the NE 102 configures some QoS parameter or requirements for a group of inter-dependent or inter-related bearers. In one example some latency bound for the transmission of data of two different LCH or bearers is configured in order to ensure some synchronization between the two bearers or LCHs. This latency bound defines for example the maximum latency which is tolerated between the transmission of PDU sets or data packets of the two bearers or LCHs, e.g., packets of a PDU set of the two bearers or LCHs are transmitted or received within the configured delay bound.

According to one example, a DSR report contains not only remaining delay information for a PDU set but also in addition delay information for the corresponding inter-dependent PDU set, e.g., information on the remaining time which is tolerated between the transmission of the dependent PDU set(s). Such information provides the scheduler with a comprehensive view of the inter-dependent LCHs/PDU sets, e.g., scheduler can allocate UL resource for the inter-dependent PDU set(s).

In one example the amount of data associated with the reported remaining delay information within a DSR comprises also the amount of data of the inter-dependent PDU set(s). According to one example, the amount of data contains the data volume of all PDU set(s) which are inter-dependent.

Accordingly, in one or more implementations DSR reporting in case of PSI-based discarding is applied. DSR is not reported based on preconfigured threshold for congestion. In one or more implementations the control message enabling congestion mode operation it is also signaled whether DSR threshold-based reporting is enabled or not. Additionally or alternatively, for low important PDU sets, no DSR reporting is configured. DSR reporting is configured per PSI (for congestion mode). Additionally or alternatively, DSR reporting is based on PSI or based on congestion. Additionally or alternatively, one DSR threshold configuration for congestion and one for non-congestion. Additionally or alternatively, DSR may be reported only for high priority PSI. Additionally or alternatively, DSR is only triggered for PDU sets for which PDCP discard timer value was not changed. Additionally or alternatively, aperiodic DSR reporting is performed based on NE request before congestion. Additionally or alternatively, the full status of data, together with BSR, is reported.

In one or more implementations, BSR reporting enhancements are included. In one or more implementations, BSR reporting is performed only for data for which remaining delay is bigger than a threshold. Additionally or alternatively, the BSR reporting accounts for data above PSI level, e.g., does not report low importance data. Additionally or alternatively, the same is applied for DSR. Additionally or alternatively, BSR/DSR is triggered when the NE indication (congestion indication) is received. Additionally or alternatively, BSR/DSR is triggered when PDCP discard timer values have been changed. Additionally or alternatively, if data volume change is bigger than a threshold trigger BSR, e.g., if data volume has changed due to discarding more than X bytes, BSR with up-to-date data volume (invalidation of previous BSR as we filed already) is reported. Additionally or alternatively, the BSR is updated only if the difference is above a threshold (trigger is amount of discarding is bigger than a threshold).

With respect to DSR reporting format, in one or more implementations PSI levels are reported to the NE since the NE does not know PSI information for UL (no inband signaling). Additionally or alternatively, the DSR format includes remaining delay, associated data, PSI level. Additionally or alternatively, the DSR reporting is based on only one trigger per PDU set (for the case of different discard timer length for different PDUs of a PDU set). Additionally or alternatively, DSR is triggered only once per PDU set. Additionally or alternatively, with respect to remaining time+associated data, only the data which has not been delivered to lower layers is reported (similar to BSR definition). Additionally or alternatively, DSR for multi-modal may also include relative delay info for related dependent bearer. Additionally or alternatively, data associated with remaining time comprises also dependent data of associated bearers.

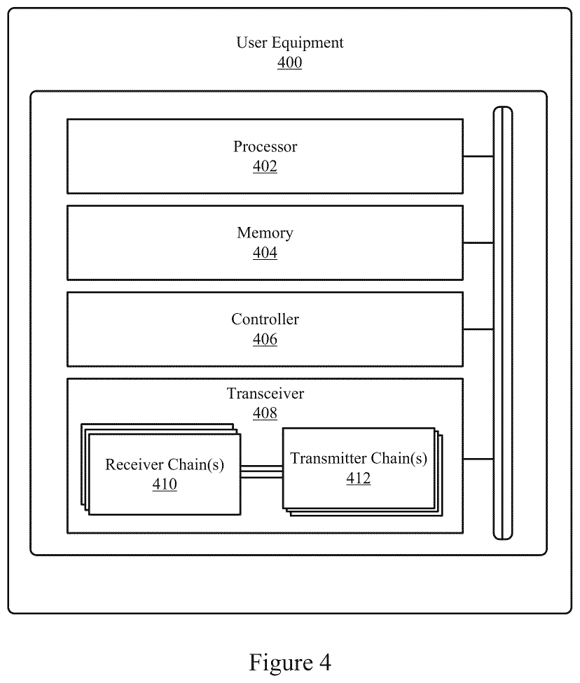

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to or operable to support a means for receiving, from a NE, a first signaling indicating whether congestion is present in a wireless communications system; transmitting, to the NE based at least in part on the first signaling indicating congestion is not present in the wireless communications system and on DSR being enabled, a second signaling indicating a DSR report for the UE; and suspending transmission, to the NE based at least in part on the first signaling indicating congestion is present in the wireless communications system, of a third signaling indicating the DSR report for the UE.

Additionally, the UE 400 may be configured to support any one or combination of receiving, from the NE, a fourth signaling indicating whether DSR is enabled or disabled; where the first signaling and the fourth signaling are both received from the NE in one message; enabling, in response to the first signaling, importance level based discarding of data at the UE; receiving, from the NE, a fourth signaling indicating that DSR is enabled; and transmitting, to the NE, the second signaling based on the importance level based discarding of data being enabled and in response to the fourth signaling indicating that DSR is enabled; receiving, from the NE, a fourth signaling indicating a lack of congestion in the wireless communications system; and resuming transmission, to the NE based at least in part on the fourth signaling indicating the lack of congestion in the wireless communications system and on the DSR being enabled, a fifth signaling indicating a DSR report for the UE; where a first PDU set is associated with a first importance level and a second PDU set is associated with a second importance level that is of higher importance than the first importance level, and further including: suspending transmission, to the NE based at least in part on the first signaling indicating congestion is present in the wireless communications system and on the DSR being enabled, of the third signaling indicating the DSR report for the UE, where the DSR report corresponds to the first PDU set; and transmitting, to the NE based at least in part on the first signaling indicating congestion is present in the wireless communications system and on the DSR being enabled, of fourth signaling indicating an additional DSR report for the UE, where the additional DSR report corresponds to the second PDU set; where the first importance level indicates low priority and the second importance level indicates high priority; where the first importance level and the second importance level are each one of three or more importance levels, and further including: transmitting, to the NE, a fourth signaling indicating which of the three or more importance levels are deemed to be more important to the UE and which of the three or more importance levels are deemed to be less important to the UE; further including: receiving, from the NE, a fourth signaling indicating a request for the DSR report for the UE; and transmitting, to the NE, a fifth signaling indicating the DSR report for the UE; where the fifth signaling also indicates a BSR for the UE; further including transmitting, to the NE based at least in part on the first signaling indicating congestion is present in the wireless communications system, a fourth signaling indicating a BSR for the UE; where the DSR report indicates delay information for a first PDU set and delay information for a second PDU set that is inter-dependent on the first PDU set.

Additionally, or alternatively, the UE 400 may support to receive, from a NE, a first signaling indicating whether congestion is present in a wireless communications system; transmit, to the NE based at least in part on the first signaling indicating congestion is not present in the wireless communications system and on DSR being enabled, a second signaling indicating a DSR report for the UE; and suspend transmission, to the NE based at least in part on the first signaling indicating congestion is present in the wireless communications system, of a third signaling indicating the DSR report for the UE.

Additionally, the UE 400 may be configured to support any one or combination of receive, from the NE, a fourth signaling indicating whether DSR is enabled or disabled; where the first signaling and the fourth signaling are both received from the NE in one message; enable, in response to the first signaling, importance level based discarding of data at the UE; receive, from the NE, a fourth signaling indicating that DSR is enabled; and transmit, to the NE, the second signaling based on the importance level based discarding of data being enabled and in response to the fourth signaling indicating that DSR is enabled; receive, from the NE, a fourth signaling indicating a lack of congestion in the wireless communications system; and resume transmission, to the NE based at least in part on the fourth signaling indicating the lack of congestion in the wireless communications system and on the DSR being enabled, a fifth signaling indicating a DSR report for the UE; where a first PDU set is associated with a first importance level and a second PDU set is associated with a second importance level that is of higher importance than the first importance level, and: suspend transmission, to the NE based at least in part on the first signaling indicating congestion is present in the wireless communications system and on the DSR being enabled, of the third signaling indicating the DSR report for the UE, where the DSR report corresponds to the first PDU set; and transmit, to the NE based at least in part on the first signaling indicating congestion is present in the wireless communications system and on the DSR being enabled, of fourth signaling indicating an additional DSR report for the UE, where the additional DSR report corresponds to the second PDU set; where the first importance level indicates low priority and the second importance level indicates high priority; where the first importance level and the second importance level are each one of three or more importance levels, and transmit, to the NE, a fourth signaling indicating which of the three or more importance levels are deemed to be more important to the UE and which of the three or more importance levels are deemed to be less important to the UE; receive, from the NE, a fourth signaling indicating a request for the DSR report for the UE; and transmit, to the NE, a fifth signaling indicating the DSR report for the UE; where the fifth signaling also indicates a BSR for the UE; transmit, to the NE based at least in part on the first signaling indicating congestion is present in the wireless communications system, a fourth signaling indicating a BSR for the UE; where the DSR report indicates delay information for a first PDU set and delay information for a second PDU set that is inter-dependent on the first PDU set.

Additionally or alternatively, the UE 400 may be configured to or operable to support a means for receiving a first signaling indicating whether congestion is present in a wireless communications system; receiving a second signaling indicating a first discard timer configuration and a second discard timer configuration, where the second discard timer configuration is comprised of a shorter discard timer value than a discard timer value of the first discard timer configuration; and prohibiting triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present.

Additionally, the UE 400 may be configured to support any one or combination of triggering transmission of the third signaling indicating the DSR report only for data for which the first discard timer configuration is applied in response to first signaling indicating congestion; triggering the transmission of the third signaling indicating a DSR report in response to a remaining delay of data for which the first discard timer configuration is applied becoming less than a predefined threshold apply the second discard timer configuration for data that is associated with a low importance level in response to the first signaling indicating congestion is present in the wireless communications system; applying the first discard timer configuration for data that is associated with a high importance level in response to the first signaling indicating congestion is present in the wireless communications system; where the first signaling indicates that PSI based discarding is enabled; receiving a fourth signaling indicating whether DSR is enabled or disabled; receiving a fourth signaling indicating a request for the DSR report for the UE; transmitting a fifth signaling indicating the DSR report for the UE; where the fifth signaling also indicates a BSR for the UE; where the DSR report indicates delay information for a first PDU set and delay information for a second PDU set that is inter-dependent on the first PDU set.

Additionally, or alternatively, the UE 400 may support to receive a first signaling indicating whether congestion is present in a wireless communications system; receive a second signaling indicating a first discard timer configuration and a second discard timer configuration, where the second discard timer configuration is comprised of a shorter discard timer value than a discard timer value of the first discard timer configuration; and prohibit triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present.

Additionally, the UE 400 may be configured to support any one or combination of trigger transmission of the third signaling indicating the DSR report only for data for which the first discard timer configuration is applied in response to first signaling indicating congestion; trigger the transmission of the third signaling indicating a DSR report in response to a remaining delay of data for which the first discard timer configuration is applied becoming less than a predefined threshold; apply the second discard timer configuration for data that is associated with a low importance level in response to the first signaling indicating congestion is present in the wireless communications system; apply the first discard timer configuration for data that is associated with a high importance level in response to the first signaling indicating congestion is present in the wireless communications system; where the first signaling indicates that PSI based discarding is enabled; receive a fourth signaling indicating whether DSR is enabled or disabled; receive a fourth signaling indicating a request for the DSR report for the UE; transmit a fifth signaling indicating the DSR report for the UE; where the fifth signaling also indicates a BSR for the UE; where the DSR report indicates delay information for a first PDU set and delay information for a second PDU set that is inter-dependent on the first PDU set.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

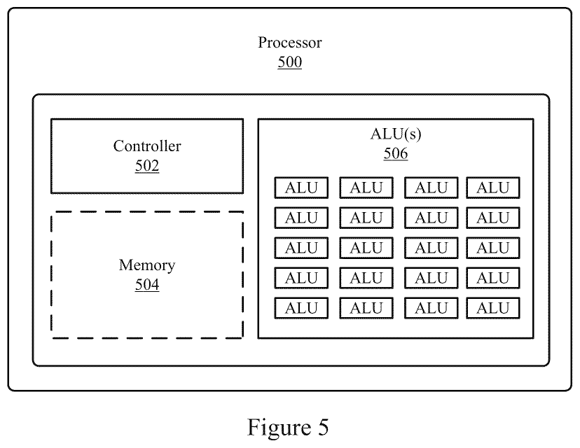

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory addresses of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs 506, and other functional units of the processor 500.

The memory 504 may include one or more caches (e.g., memory local to or included in the processor 500 or other memory, such as RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, and the controller 502, and may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 may be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to: receive, from a NE, a first signaling indicating whether congestion is present in a wireless communications system; transmit, to the NE based at least in part on the first signaling indicating congestion is not present in the wireless communications system and on DSR being enabled, a second signaling indicating a DSR report for a UE including the processor; and suspend transmission, to the NE based at least in part on the first signaling indicating congestion is present in the wireless communications system, of a third signaling indicating the DSR report for the UE.

Additionally, the processor 500 may be configured to support any one or combination of receive, from the NE, a fourth signaling indicating whether DSR is enabled or disabled; where the first signaling and the fourth signaling are both received from the NE in one message; enable, in response to the first signaling, importance level based discarding of data at the UE; receive, from the NE, a fourth signaling indicating that DSR is enabled; and transmit, to the NE, the second signaling based on the importance level based discarding of data being enabled and in response to the fourth signaling indicating that DSR is enabled; receive, from the NE, a fourth signaling indicating a lack of congestion in the wireless communications system; and resume transmission, to the NE based at least in part on the fourth signaling indicating the lack of congestion in the wireless communications system and on the DSR being enabled, a fifth signaling indicating a DSR report for the UE; where a first PDU set is associated with a first importance level and a second PDU set is associated with a second importance level that is of higher importance than the first importance level, and: suspend transmission, to the NE based at least in part on the first signaling indicating congestion is present in the wireless communications system and on the DSR being enabled, of the third signaling indicating the DSR report for the UE, where the DSR report corresponds to the first PDU set; and transmit, to the NE based at least in part on the first signaling indicating congestion is present in the wireless communications system and on the DSR being enabled, of fourth signaling indicating an additional DSR report for the UE, where the additional DSR report corresponds to the second PDU set; where the first importance level indicates low priority and the second importance level indicates high priority; where the first importance level and the second importance level are each one of three or more importance levels, and transmit, to the NE, a fourth signaling indicating which of the three or more importance levels are deemed to be more important to the UE and which of the three or more importance levels are deemed to be less important to the UE; receive, from the NE, a fourth signaling indicating a request for the DSR report for the UE; and transmit, to the NE, a fifth signaling indicating the DSR report for the UE; where the fifth signaling also indicates a BSR for the UE; transmit, to the NE based at least in part on the first signaling indicating congestion is present in the wireless communications system, a fourth signaling indicating a BSR for the UE; where the DSR report indicates delay information for a first PDU set and delay information for a second PDU set that is inter-dependent on the first PDU set.

Additionally or alternatively, the processor 500 may be configured to or operable to: receive a first signaling indicating whether congestion is present in a wireless communications system; receive a second signaling indicating a first discard timer configuration and a second discard timer configuration, where the second discard timer configuration is comprised of a shorter discard timer value than a discard timer value of the first discard timer configuration; and prohibit triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present.

Additionally, the processor 500 may be configured to support any one or combination of trigger transmission of the third signaling indicating the DSR report only for data for which the first discard timer configuration is applied in response to first signaling indicating congestion; trigger the transmission of the third signaling indicating a DSR report in response to a remaining delay of data for which the first discard timer configuration is applied becoming less than a predefined threshold; apply the second discard timer configuration for data that is associated with a low importance level in response to the first signaling indicating congestion is present in the wireless communications system; apply the first discard timer configuration for data that is associated with a high importance level in response to the first signaling indicating congestion is present in the wireless communications system; where the first signaling indicates that PSI based discarding is enabled.

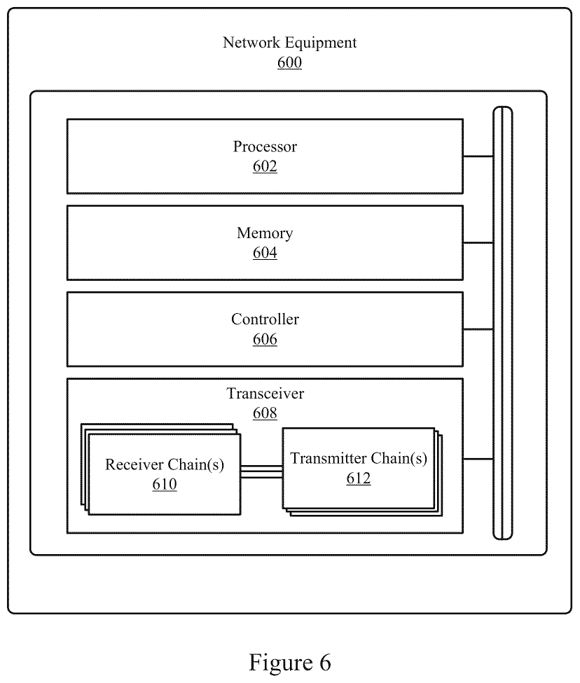

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to or operable to support a means for transmitting, to a UE, a first signaling indicating whether congestion is present in a wireless communications system; and receiving, from the UE based at least in part on the first signaling indicating congestion is not present in the wireless communications system and on DSR being enabled, a second signaling indicating a DSR report for the UE.

Additionally, the NE 600 may be configured to support any one or combination of transmitting, to the UE, a third signaling indicating whether DSR is enabled or disabled; where the first signaling and the third signaling are both transmitted to the UE in one message; transmitting, to the UE, a third signaling indicating that DSR is enabled; and receiving, from the UE, the third signaling based on an importance level based discarding of data being enabled and in response to DSR being enabled; transmitting, to the UE, a third signaling indicating a lack of congestion in the wireless communications system; and receiving, from the UE based at least in part on the third signaling indicating the lack of congestion in the wireless communications system and on the DSR being enabled, a fourth signaling indicating a DSR report for the UE; where a first PDU set is associated with a first importance level and a second PDU set is associated with a second importance level that is of higher importance than the first importance level, and further including: receiving, from the UE based at least in part on the first signaling indicating congestion is present in the wireless communications system and on the DSR being enabled, third signaling indicating an additional DSR report for the UE, where the additional DSR report corresponds to the second PDU set; where the first importance level indicates low priority and the second importance level indicates high priority; where the first importance level and the second importance level are each one of three or more importance levels, and further including: receiving, from the UE, a fourth signaling indicating which of the three or more importance levels are deemed to be more important to the UE and which of the three or more importance levels are deemed to be less important to the UE; transmitting, to the UE, a third signaling indicating a request for the DSR report for the UE; and receiving, from the UE, a fourth signaling indicating the DSR report for the UE; where the fourth signaling also indicates a BSR for the UE; receiving, from the UE based at least in part on the first signaling indicating congestion is present in the wireless communications system, a fourth signaling indicating a BSR for the UE; where the DSR report indicates delay information for a first PDU set and delay information for a second PDU set that is inter-dependent on the first PDU set.

Additionally, or alternatively, the NE 600 may support to: transmit, to a UE, a first signaling indicating whether congestion is present in a wireless communications system; and receive, from the UE based at least in part on the first signaling indicating congestion is not present in the wireless communications system and on DSR being enabled, a second signaling indicating a DSR report for the UE.

Additionally, the NE 600 may be configured to support any one or combination of transmit, to the UE, a third signaling indicating whether DSR is enabled or disabled; where the first signaling and the third signaling are both transmitted to the UE in one message; transmit, to the UE, a third signaling indicating that DSR is enabled; and receive, from the UE, the third signaling based on an importance level based discarding of data being enabled and in response to DSR being enabled; transmit, to the UE, a third signaling indicating a lack of congestion in the wireless communications system; and receive, from the UE based at least in part on the third signaling indicating the lack of congestion in the wireless communications system and on the DSR being enabled, a fourth signaling indicating a DSR report for the UE; where a first PDU set is associated with a first importance level and a second PDU set is associated with a second importance level that is of higher importance than the first importance level, and receive, from the UE based at least in part on the first signaling indicating congestion is present in the wireless communications system and on the DSR being enabled, third signaling indicating an additional DSR report for the UE, where the additional DSR report corresponds to the second PDU set; where the first importance level indicates low priority and the second importance level indicates high priority; where the first importance level and the second importance level are each one of three or more importance levels, and receive, from the UE, a fourth signaling indicating which of the three or more importance levels are deemed to be more important to the UE and which of the three or more importance levels are deemed to be less important to the UE; transmit, to the UE, a third signaling indicating a request for the DSR report for the UE; and receive, from the UE, a fourth signaling indicating the DSR report for the UE; where the fourth signaling also indicates a BSR for the UE; receive, from the UE based at least in part on the first signaling indicating congestion is present in the wireless communications system, a fourth signaling indicating a BSR for the UE; where the DSR report indicates delay information for a first PDU set and delay information for a second PDU set that is inter-dependent on the first PDU set.

Additionally or alternatively, the NE 600 may be configured to or operable to support a means for transmitting a first signaling indicating whether congestion is present in a wireless communications system; transmitting a second signaling indicating a first discard timer configuration and a second discard timer configuration, where the second discard timer configuration is comprised of a shorter discard timer value than a discard timer value of the first discard timer configuration; and receiving a third signaling indicating a DSR report only for data for which the first discard timer configuration is applied in response to the first signaling indicating congestion is present.

Additionally, the NE 600 may be configured to support where the first signaling indicates that PSI based discarding is enabled.

Additionally, or alternatively, the NE 600 may support to transmit a first signaling indicating whether congestion is present in a wireless communications system; transmit a second signaling indicating a first discard timer configuration and a second discard timer configuration, where the second discard timer configuration is comprised of a shorter discard timer value than a discard timer value of the first discard timer configuration; and receive a third signaling indicating a DSR report only for data for which the first discard timer configuration is applied in response to the first signaling indicating congestion is present.

Additionally, the NE 600 may be configured to support where the first signaling indicates that PSI based discarding is enabled.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

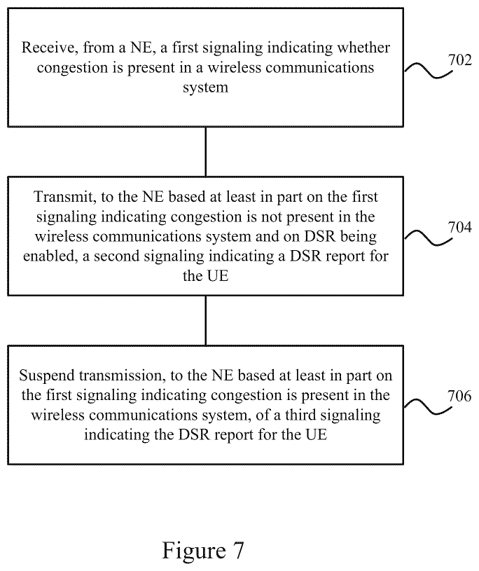

FIG. 7 illustrates a flowchart of a method in accordance with aspects of the present disclosure. The operations of the method may be implemented by a UE as described herein. In some implementations, the UE may execute a set of instructions to control the function elements of the UE to perform the described functions.

At 702, the method may include receiving, from a NE, a first signaling indicating whether congestion is present in a wireless communications system. The operations of 702 may be performed in accordance with examples as described herein. In some implementations, aspects of the operations of 702 may be performed by a UE as described with reference to FIG. 4.

At 704, the method may include transmitting, to the NE based at least in part on the first signaling indicating congestion is not present in the wireless communications system and on DSR being enabled, a second signaling indicating a DSR report for the UE. The operations of 704 may be performed in accordance with examples as described herein. In some implementations, aspects of the operations of 704 may be performed by a UE as described with reference to FIG. 4.

At 706, the method may include suspending transmission, to the NE based at least in part on the first signaling indicating congestion is present in the wireless communications system, of a third signaling indicating the DSR report for the UE. The operations of 706 may be performed in accordance with examples as described herein. In some implementations, aspects of the operations of 706 may be performed a UE as described with reference to FIG. 4.

It should be noted that the method described herein describes a possible implementation, and that the operations and the steps may be rearranged or otherwise modified and that other implementations are possible.

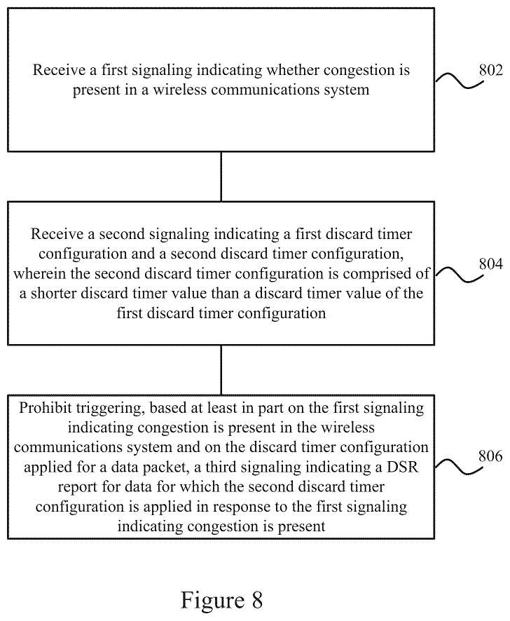

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include receiving a first signaling indicating whether congestion is present in a wireless communications system. The operations of 802 may be performed in accordance with examples as described herein. In some implementations, aspects of the operations of 802 may be performed by a UE as described with reference to FIG. 4.

At 804, the method may include receiving a second signaling indicating a first discard timer configuration and a second discard timer configuration, wherein the second discard timer configuration is comprised of a shorter discard timer value than a discard timer value of the first discard timer configuration. The operations of 804 may be performed in accordance with examples as described herein. In some implementations, aspects of the operations of 804 may be performed by a UE as described with reference to FIG. 4.

At 806, the method may include prohibiting triggering, based at least in part on the first signaling indicating congestion is present in the wireless communications system and on the discard timer configuration applied for a data packet, a third signaling indicating a DSR report for data for which the second discard timer configuration is applied in response to the first signaling indicating congestion is present. The operations of 806 may be performed in accordance with examples as described herein. In some implementations, aspects of the operations of 806 may be performed a UE as described with reference to FIG. 4.

It should be noted that the method described herein describes a possible implementation, and that the operations and the steps may be rearranged or otherwise modified and that other implementations are possible.

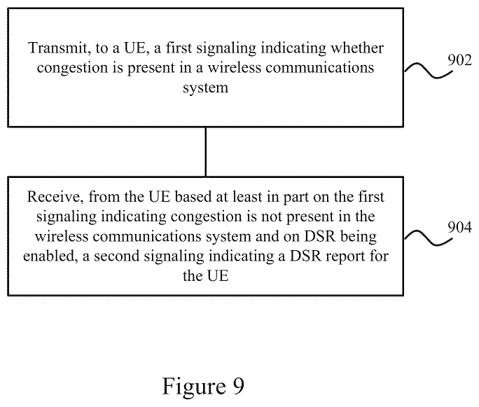

FIG. 9 illustrates a flowchart of a method in accordance with aspects of the present disclosure. The operations of the method may be implemented by a NE as described herein. In some implementations, the NE may execute a set of instructions to control the function elements of the NE to perform the described functions.

At 902, the method may include transmitting, to a UE, a first signaling indicating whether congestion is present in a wireless communications system. The operations of 902 may be performed in accordance with examples as described herein. In some implementations, aspects of the operations of 902 may be performed by a NE as described with reference to FIG. 6.

At 904, the method may include receiving, from the UE based at least in part on the first signaling indicating congestion is not present in the wireless communications system and on DSR being enabled, a second signaling indicating a DSR report for the UE. The operations of 904 may be performed in accordance with examples as described herein. In some implementations, aspects of the operations of 904 may be performed by a NE as described with reference to FIG. 6.

It should be noted that the method described herein describes a possible implementation, and that the operations and the steps may be rearranged or otherwise modified and that other implementations are possible.

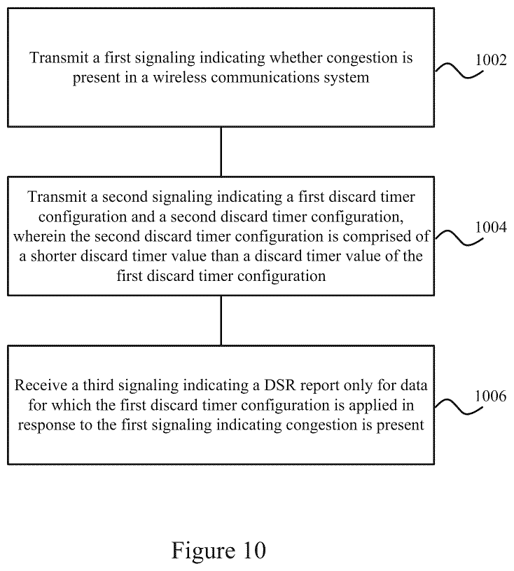

FIG. 10 illustrates a flowchart of a method in accordance with aspects of the present disclosure. The operations of the method may be implemented by a NE as described herein. In some implementations, the NE may execute a set of instructions to control the function elements of the NE to perform the described functions.

At 1002, the method may include transmitting a first signaling indicating whether congestion is present in a wireless communications system. The operations of 1002 may be performed in accordance with examples as described herein. In some implementations, aspects of the operations of 1002 may be performed by a NE as described with reference to FIG. 6.

At 1004, the method may include transmitting a second signaling indicating a first discard timer configuration and a second discard timer configuration, wherein the second discard timer configuration is comprised of a shorter discard timer value than a discard timer value of the first discard timer configuration. The operations of 1004 may be performed in accordance with examples as described herein. In some implementations, aspects of the operations of 1004 may be performed by a NE as described with reference to FIG. 6.

At 1006, the method may include receiving a third signaling indicating a DSR report only for data for which the first discard timer configuration is applied in response to the first signaling indicating congestion is present. The operations of 1006 may be performed in accordance with examples as described herein. In some implementations, aspects of the operations of 1006 may be performed by a NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a first signaling indicating whether congestion is present in a wireless communications system;
receive a second signaling indicating a first discard timer configuration and a second discard timer configuration, wherein the second discard timer configuration is comprised of a shorter discard timer value than a discard timer value of the first discard timer configuration; and
prohibit triggering, based at least in part on the first signaling indicating congestion is present in the wireless communications system and on the discard timer configuration applied for a data packet, a third signaling indicating a delay status reporting (DSR) report for data for which the second discard timer configuration is applied in response to the first signaling indicating congestion is present.

2. The UE of claim 1, wherein the at least one processor is configured to cause the UE to trigger transmission of the third signaling indicating the DSR report only for data for which the first discard timer configuration is applied in response to first signaling indicating congestion.

3. The UE of claim 2, wherein the at least one processor is configured to cause the UE to trigger the transmission of the third signaling indicating a DSR report in response to a remaining delay of data for which the first discard timer configuration is applied becoming less than a predefined threshold.

4. The UE of claim 1, wherein the at least one processor is configured to cause the UE to apply the second discard timer configuration for data that is associated with a low importance level in response to the first signaling indicating congestion is present in the wireless communications system.

5. The UE of claim 1, wherein the at least one processor is configured to cause the UE to apply the first discard timer configuration for data that is associated with a high importance level in response to the first signaling indicating congestion is present in the wireless communications system.

6. The UE of claim 1, wherein the first signaling indicates that packet data unit (PDU) set importance level (PSI) based discarding is enabled.

7. The UE of claim 1, wherein the at least one processor is configured to cause the UE to receive a fourth signaling indicating whether DSR is enabled or disabled.

8. The UE of claim 1, wherein the at least one processor is configured to cause the UE to:
receive a fourth signaling indicating a request for the DSR report for the UE; and
transmit a fifth signaling indicating the DSR report for the UE.

9. The UE of claim 8, wherein the fifth signaling also indicates a buffer status report (BSR) for the UE.

10. The UE of claim 1, wherein the DSR report indicates delay information for a first packet data unit (PDU) set and delay information for a second PDU set that is inter-dependent on the first PDU set.

11. A processor for wireless communication, comprising:
at least one controller coupled with at least one memory and configured to cause the processor to:
receive a first signaling indicating whether congestion is present in a wireless communications system;
receive a second signaling indicating a first discard timer configuration and a second discard timer configuration, wherein the second discard timer configuration is comprised of a shorter discard timer value than a discard timer value of the first discard timer configuration; and
prohibit triggering, based at least in part on the first signaling indicating congestion is present in the wireless communications system and on the discard timer configuration applied for a data packet, a third signaling indicating a delay status reporting (DSR) report for data for which the second discard timer configuration is applied in response to the first signaling indicating congestion is present.

12. The processor of claim 11, wherein the at least one controller is configured to cause the processor to trigger transmission of the third signaling indicating the DSR report only for data for which the first discard timer configuration is applied in response to first signaling indicating congestion.

13. The processor of claim 12, wherein the at least one controller is configured to cause the processor to trigger the transmission of the third signaling indicating a DSR report in response to a remaining delay of data for which the first discard timer configuration is applied becoming less than a predefined threshold.

14. The processor of claim 11, wherein the at least one controller is configured to cause the processor to apply the second discard timer configuration for data that is associated with a low importance level in response to the first signaling indicating congestion is present in the wireless communications system.

15. The processor of claim 11, wherein the at least one controller is configured to cause the processor to apply the first discard timer configuration for data that is associated with a high importance level in response to the first signaling indicating congestion is present in the wireless communications system.

16. The processor of claim 11, wherein the first signaling indicates that packet data unit (PDU) set importance level (PSI) based discarding is enabled.

17. A base station for wireless communication, comprising:
at least one memory; and
at least one processor coupled with the at least one memory and configured to cause the base station to:
transmit a first signaling indicating whether congestion is present in a wireless communications system;
transmit a second signaling indicating a first discard timer configuration and a second discard timer configuration, wherein the second discard timer configuration is comprised of a shorter discard timer value than a discard timer value of the first discard timer configuration; and
receive a third signaling indicating a delay status reporting (DSR) report only for data for which the first discard timer configuration is applied in response to the first signaling indicating congestion is present.

18. The base station of claim 17, wherein the first signaling indicates that packet data unit (PDU) set importance level (PSI) based discarding is enabled.

19. A method performed by a user equipment (UE), the method comprising:
receiving a first signaling indicating whether congestion is present in a wireless communications system;
receiving a second signaling indicating a first discard timer configuration and a second discard timer configuration, wherein the second discard timer configuration is comprised of a shorter discard timer value than a discard timer value of the first discard timer configuration; and
prohibiting triggering, based at least in part on the first signaling indicating congestion is present in the wireless communications system and on the discard timer configuration applied for a data packet, a third signaling indicating a delay status reporting (DSR) report for data for which the second discard timer configuration is applied in response to the first signaling indicating congestion is present.

20. The method of claim 19, further comprising triggering transmission of the third signaling indicating the DSR report only for data for which the first discard timer configuration is applied in response to first signaling indicating congestion.
